(19) United States
(12) Patent Application Publication
(10) Pub. No.: US 2009/0300411 A1
(43) Pub. Date: Dec. 3, 2009

(54) Implementing Redundant Memory Access Using Multiple Controllers for Memory System

(76) Inventors: Gerald Keith Bartley, Rochester, MN (US); Darryl John Becker, Rochester, MN (US); John Michael Borkenhagen, Rochester, MN (US); Paul Eric Dahlen, Rochester, MN (US); Philip Raymond Germann, Oronoco, MN (US); William Paul Hovis, Rochester, MN (US); Mark Owen Maxson, Mantorville, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/132,120

(22) Filed: Jun. 3, 2008

(51) Int. Cl. G06F 11/14

(52) U.S. Cl. 714/6; 714/E11.113

(57) ABSTRACT

A method and apparatus implement redundant memory access using multiple controllers for a memory system, and a design structure on which the subject circuit resides are provided. A first memory controller uses a first memory and a second memory controller uses the second memory as its respective primary address space, for storage and fetches. The second memory controller is also connected to the first memory. The first memory controller is also connected to the second memory. The first memory controller and the second memory controller, for example, are connected together by a processor communications bus. When one of the first memory controller or the second memory controller fails, then the other memory controller is notified. The other memory controller takes control of the memory for the failed controller, using the direct connection to that memory, and maintains coherence of both the first memory and second memory.

### FIELD OF THE INVENTION

The present invention relates generally to the data processing field, and more particularly, relates to a method and apparatus for implementing redundant memory access using multiple controllers for a memory system, and a design structure on which the subject circuit resides.

### RELATED APPLICATION

A related United States patent application assigned to the present assignee is being filed on the same day as the present patent application including:

U.S. patent application Ser. No. ______, by Gerald Keith Bartley, and entitled “IMPLEMENTING CACHE COHERENCY AND REDUCED LATENCY USING MULTIPLE CONTROLLERS FOR MEMORY SYSTEM”.

### DESCRIPTION OF THE RELATED ART

In today's server systems, the loss of data in a component or power failure can be devastating to a business' operations. The ability to fail-over components of the server system and applications is critical to the successful implementation of multi-processor systems.

Conventional processor-to-memory architectures utilize data coherency models that require each processor to have a single access point to either its own dedicated memory, or a bank of memory shared among many processors.

FIG. 1 illustrates a conventional memory system. A first processor or memory controller 1 includes a data path 1 and a primary memory control path 1 to a chain of dedicated memory. A second processor or memory controller 2 includes a data path 2 and a primary memory control path 2 to a separate chain of dedicated memory. The two processors or memory controllers 1, 2 are connected by a processor communication bus.

Typically cache coherence requirements prohibit simply connecting another processor to a bank of memory. For example, in a simple case such as a multiprocessor system, if one processor has requested a block of data for an operation, another processor cannot use the same data until the first one has completed its operation and returned the data to the memory bank, or invalidated the data in the memory. This requirement can be avoided by allowing each controller to independently maintain its own segregated memory bank, such as illustrated in the prior art memory system of FIG. 1.

In the case where each processor is given a dedicated memory space, a failure of the processor can lead to the loss of data, both in the on-chip caches, and in the mainstore memory.

U.S. patent application Ser. No. 11/758,732 filed Jun. 6, 2007, and assigned to the present assignee, discloses a method and apparatus for implementing redundant memory access using multiple controllers on the same bank of memory. A first memory controller uses the memory as its primary address space, for storage and fetches. A second redundant controller is also connected to the same memory. System control logic is used to notify the redundant controller of the need to take over the memory interface. The redundant controller initializes if required and takes control of the memory. The memory only needs to be initialized if the system has to be brought down and restarted in the redundant mode.

While the above-identified patent application provides improvements over the prior art arrangements, there is no simultaneous access of the memory by more than one controller. When a primary controller fails, the redundant controller assumes full control and access to the memory, providing an alternate access path to the memory.

It is highly desirable to be able to allow multiple controllers to quickly and efficiently gain access to memory, and provide enhanced fail-over performance. A need exists for an effective mechanism that enables implementing redundant memory access using multiple controllers for a memory system.

### SUMMARY OF THE INVENTION

Principal aspects of the present invention are to provide a method and apparatus for implementing redundant memory access using multiple controllers on first and second daisy chains of memory for a memory system, and a design structure on which the subject circuit resides. Other important aspects of the present invention are to provide such method and apparatus for implementing redundant memory access using multiple controllers on first and second daisy chains of memory substantially without negative effect and that overcome many of the disadvantages of prior art arrangements.

In brief, a method and apparatus for implementing redundant memory access using multiple controllers for a memory system, and a design structure on which the subject circuit resides are provided. A first memory and a memory are connected to multiple memory controllers. A first memory controller uses the first memory as its primary address space, for storage and fetches. A second memory controller is also connected to the first memory. The second memory controller uses the second memory as its primary address space, for storage and fetches. The first memory controller is also connected to the second memory. The first memory controller and the second memory controller, for example, are connected together by a processor communications bus. When one of the first memory controller or the second memory controller fails, then the other memory controller is notified. The redundant memory controller takes control of the memory for the failed controller, using the direct connection to that memory. The redundant memory controller maintains coherence of both the first memory and second memory.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a prior art memory system;

FIGS. 2, and 3 are block diagram representations each respectively illustrating an alternative memory system in accordance with the preferred embodiment;

FIG. 4 illustrates exemplary steps performed by each exemplary memory system in accordance with the preferred embodiment; and

FIG. 5 is a flow diagram of a design process used in semiconductor design, manufacturing, and/or test.

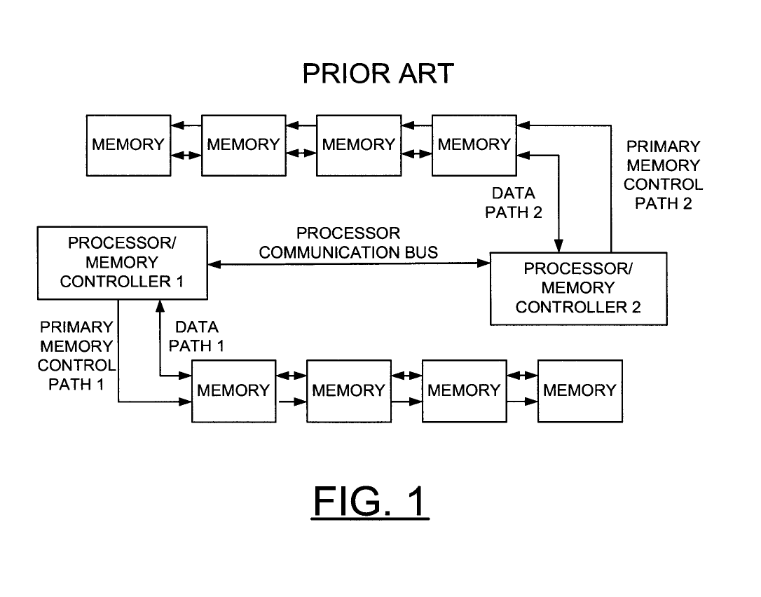

### DETAILED DESCRIPTION OF THE PREFERRED EMBODIMENTS

In accordance with features of the invention, a method and apparatus enable implementing redundant memory access using multiple controllers for a memory system, while maintaining current conventional cache coherence schemes.

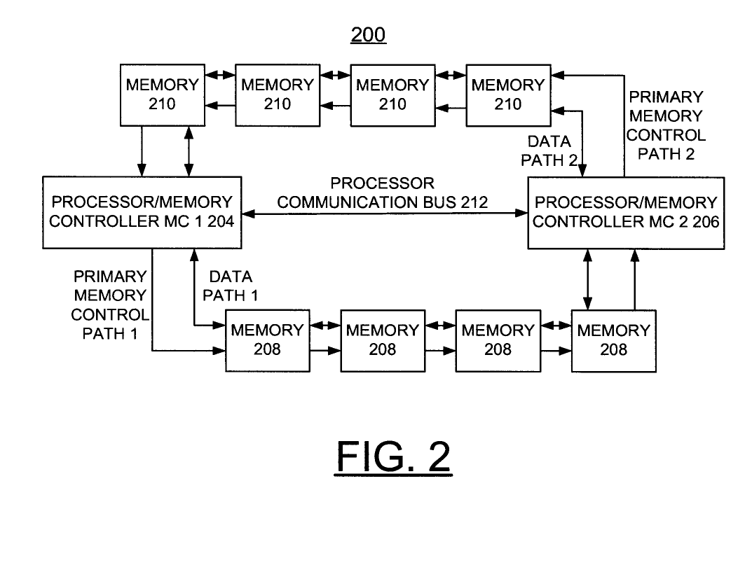

Having reference now to the drawings, in FIG. 2, there is shown a memory system generally designated by the reference character 200 in accordance with the preferred embodiment.

Memory system 200 is a dynamic random access memory (DRAM) system 200. DRAM system 200 includes a first processor or memory controller (MC 1) 204 and a second processor or memory controller (MC 2) 206. The first memory controller MC 1, 204 and the second redundant memory controller MC2, 206, for example, includes an integrated microprocessor and memory controller, such as a processor system in a package (SIP).

Each of the two controllers MC1, 204 and MC2, 206 includes dedicated memory. The first processor or memory controller MC1, 204 includes a data path 1 and a primary memory control path 1 to a chain of memory chips or modules 208, such as dynamic random access memory (DRAM) chips or modules 208. The second processor or memory controller MC2, 206 includes a data path 2 and a primary memory control path 2 to a separate chain of memory chips or modules 210, such as dynamic random access memory (DRAM) chips or modules 210. The memory controllers MC1, 204 and MC2, 206 are connected together by a processor communications bus 212.

In accordance with features of the invention, in addition to the connection of each controller MC1, 204; MC2, 206 to its bank of memory 208, 210, an additional through bus connection is made to the other controller MC1, 204; MC2, 206. The data path 1 and a primary memory control path 1 to the chain of memory 208 extend to the other controller MC2, 206. The data path 2 and a primary memory control path 2 to the chain of memory 210 extend to the other controller MC1, 204. This bus is a full-width data interface, just like the one to the primary controller.

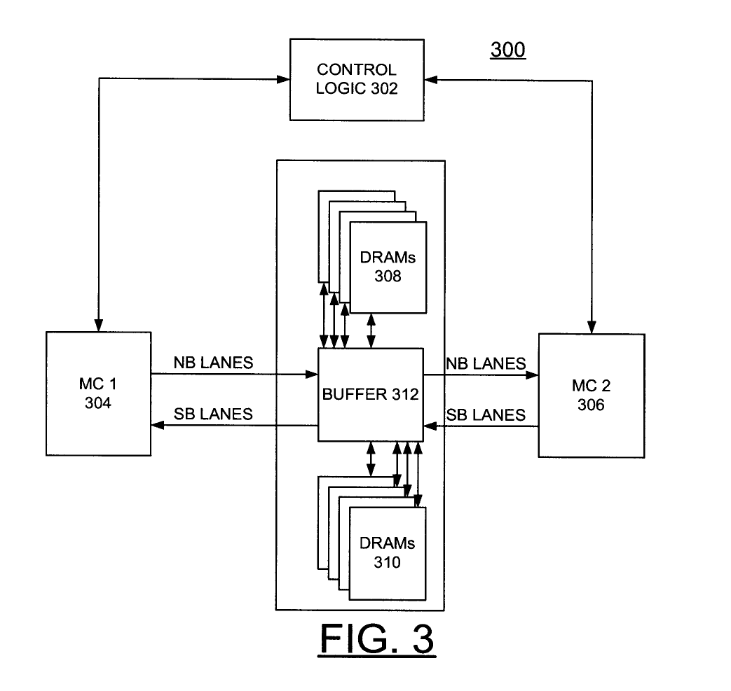

Referring also to FIG. 3, there is shown another memory system generally designated by the reference character 300 in accordance with the preferred embodiment.

Memory system 300 is a dynamic random access memory (DRAM) system 300. DRAM system 300 includes a control logic circuit 302 is connected to each of a first processor or memory controller (MC 1) 304 and a second processor or memory controller (MC 2) 306. Optionally the memory controllers MC1, 304 and MC2, 306 are connected together by a processor communications bus.

Each of the memory controllers MC 1, MC 2, 304, 306 optionally can be physically included with a respective processor within a processor package or system in a package (SIP).

For example, the first memory controller MC 1, 304 includes dedicated memory chips or modules 308, and the second memory controller MC 2, 306 includes dedicated memory chips or modules 310. The control logic circuit 302 is provided to notify the other memory controller of a failed memory controller, and to send requests between and to notify the memory controllers MC 1, MC 2, 304, 306 with respect to changed data, in order to maintain cache coherency rules.

Each of the memory controllers MC 1, MC 2, 304, 306 is connected to a memory buffer 312 via northbound (NB) and southbound (SB) lanes. Memory buffer 312 is coupled to the plurality of DRAMs 308, 310, arranged, for example, as dual inline memory module (DIMM) circuit cards. Memory system300 is a fully-buffered DIMM (FBDIMM).

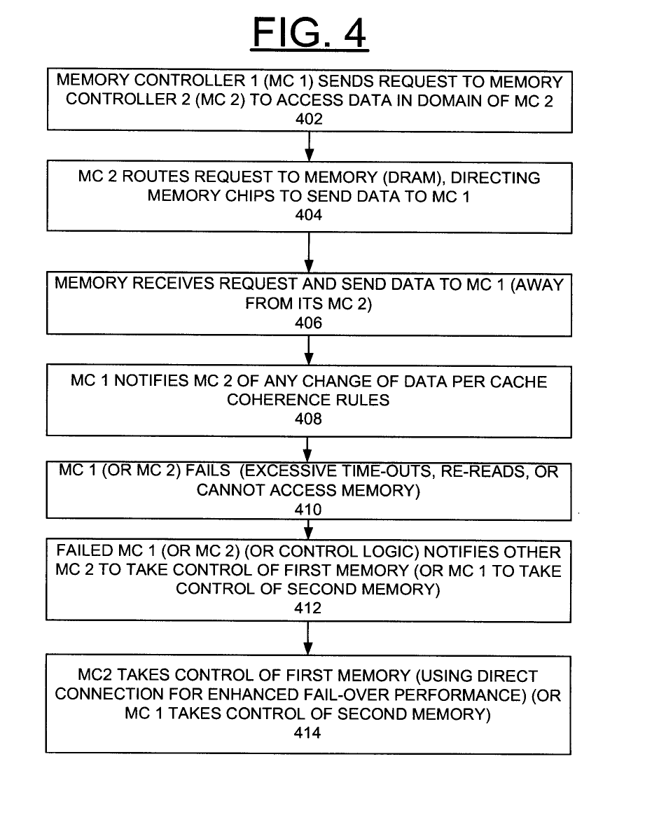

Exemplary operation of the memory system 200 and the memory system 300, is illustrated and described with respect to the exemplary steps shown in the flow chart of FIG. 4.

During normal system operation, memory system 200 and memory system 300 have the ability to receive data directly from the memory of another controller. The request and send sequence of the method of the invention sends the data directly to the requesting memory controller and eliminates the need to re-route data back through the responding controller, improving the latency of the data transfer. By avoiding the transfer through the responding controller, bandwidth through the responding controller advantageously is saved for other transfers, further improving and optimizing performance. In a more complicated sequence, the responding controller advantageously determines which path is lower latency, either routing back through the primary controller, or moving the data upstream directly to the requesting controller. Each memory controller maintains coherence of its dedicated memory, according to current conventional methods.

In accordance with features of the invention, memory system 200 and memory system 300 have the ability for each of the memory controllers MC 1, MC2 to take control of the memory for a failed controller, using the direct connection to that memory, and maintains coherence of both the first memory and second memory. When one of the first memory controller or the second memory controller fails, then the other memory controller is notified, for example, by the failing memory controller or by control logic coupled to the memory controllers MC 1, MC2.

Referring now to FIG. 4, there are shown exemplary steps performed by each exemplary memory system 200, 300 in accordance with the preferred embodiment. As indicated at a block 402, during normal operations a requesting controller, such as, the first memory controller 1 (MC 1) requests access to data in the second memory of a responding controller, such as, the second memory controller MC 2.

As indicated at a block 404, the second memory controller MC 2 routes the request to the second memory to send data to the first memory controller MC1. The MC 2 routes the request to the second memory, such as memory 210 in FIG. 2, or memory 310 in FIG. 3.

As indicated at a block 406, the second memory sends the data directly to the first memory controller MC1. The first memory controller MC 1 notifies the second controller MC 2 of any change to the data for cache coherence requirements as indicated at a block 408.

As indicated at a block 410, one of the memory controller MC 1 or MC 2 fails or is not able to access memory, excessive time-outs or re-reads occur. The failed memory controller MC 1, or MC 2, or control logic 302 notifies the other memory controller MC 2 to take control of the first memory, or MC 1 to take control of the second memory as indicated at a block 412. Then the other controller MC 2 takes control of the first memory using the direct connection to the first memory, providing enhanced fail-over performance as compared to prior art redundancy arrangements as indicated at a block 414. Alternatively the other controller MC 1 takes control of the second memory using the direct connection to the first memory, providing enhanced fail-over performance at block 414, when the second memory controller MC 2 failed at block 410. Then at block 414, the memory controller MC 2, or memory controller MC 1, controls both the first memory and second memory, and maintains coherence of both the first memory and second memory, according to current conventional methods.

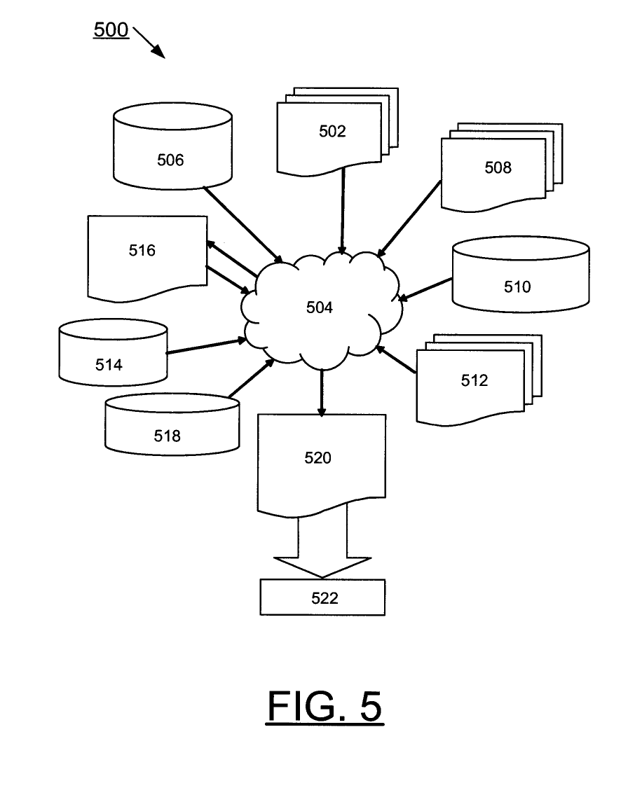

FIG. 5 shows a block diagram of an example design flow 500. Design flow 500 may vary depending on the type of IC being designed. For example, a design flow 500 for building an application specific IC (ASIC) may differ from a design flow 500 for designing a standard component. Design structure 502 is preferably an input to a design process 504 and may come from an IP provider, a core developer, or other design company or may be generated by the operator of the design flow, or from other sources. Design structure 502 comprises circuits 100, 200, 300, 400, 500, 600, 700 in the form of schematics or HDL, a hardware-description language, for example, Verilog, VHDL, C, and the like. Design structure 502 may be contained on one or more machine readable medium. For example, design structure 502 may be a text file or a graphical representation of circuits 200, 300. Design process 504 preferably synthesizes, or translates, circuits 200, 300 into a netlist 506, where netlist 506 is, for example, a list of wires, transistors, logic gates, control circuits, I/O, models, etc. that describes the connections to other elements and circuits in an integrated circuit design and recorded on at least one of machine readable medium. This may be an iterative process in which netlist 506 is resynthesized one or more times depending on design specifications and parameters for the circuits.

Design process 504 may include using a variety of inputs; for example, inputs from library elements 508 which may house a set of commonly used elements, circuits, and devices, including models, layouts, and symbolic representations, for a given manufacturing technology, such as different technology nodes, 32 nm, 45 nm, 90 nm, and the like, design specifications 510, characterization data 512, verification data 514, design rules 516, and test data files 518, which may include test patterns and other testing information. Design process 504 may further include, for example, standard circuit design processes such as timing analysis, verification, design rule checking, place and route operations, and the like. One of ordinary skill in the art of integrated circuit design can appreciate the extent of possible electronic design automation tools and applications used in design process 504 without deviating from the scope and spirit of the invention. The design structure of the invention is not limited to any specific design flow.

Design process 504 preferably translates an embodiment of the invention as shown in FIGS. 2-4 along with any additional integrated circuit design or data (if applicable), into a second design structure 520. Design structure 520 resides on a storage medium in a data format used for the exchange of layout data of integrated circuits, for example, information stored in a GDSII (GDS2), GL1, OASIS, or any other suitable format for storing such design structures. Design structure 520 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 2-4. Design structure 520 may then proceed to a stage 522 where, for example, design structure 520 proceeds to tape-out, is released to manufacturing, is released to a mask house, is sent to another design house, is sent back to the customer, and the like.

While the present invention has been described with reference to the details of the embodiments of the invention shown in the drawing, these details are not intended to limit the scope of the invention as claimed in the appended claims.

What is claimed is:

1. An apparatus for implementing redundant memory access comprising:
a first memory and a second memory;
a first memory controller and a second memory controller, each of said first memory controller and said second memory controller connected to both said first memory and said second memory; said first memory controller and said second memory connected together;
said first memory controller using said first memory as its primary address space, for storage and fetches and maintaining cache coherency;
said second memory controller using said second memory as its primary address space, for storage and fetches and maintaining cache coherency;
one of said first memory controller or said second memory controller failing;
the other one of said first memory controller or said second memory controller being notified of said failed controller and taking control of both said first memory and said second memory responsive to being notified.

2. The apparatus for implementing redundant memory access as recited in claim 1 wherein said first memory and said second memory include dynamic random access memory (DRAM).

3. The apparatus for implementing redundant memory access as recited in claim 1 includes control logic coupled to said first memory controller and said second redundant memory controller; said control logic notifying said other one of said first memory controller or said second memory controller to control of both said first memory and said second memory.

4. The apparatus for implementing redundant memory access as recited in claim 1 wherein said failed one of said first memory controller or said second memory controller notifies said other one of said first memory controller or said second memory controller to take control of both said first memory and said second memory.

5. The apparatus for implementing redundant memory access as recited in claim 1 wherein said other one of said first memory controller or said second memory controller takes control and maintains coherence of both said first memory and said second memory.

6. The apparatus for implementing redundant memory access as recited in claim 1 includes a processor communications bus connecting said first memory controller and said second memory.

7. The apparatus for implementing redundant memory access as recited in claim 1 wherein said first memory and said second memory include a daisy chain of memory chips.

8. The apparatus for implementing redundant memory access as recited in claim 1 wherein said first memory controller and said second memory controller are connected at respective ends of each said daisy chain of said first memory and said second memory.

9. The apparatus for implementing redundant memory access as recited in claim 8 includes a full-width data bus connection to each of said first memory controller and said second memory controller at respective ends of each said daisy chain.

10. The apparatus for implementing redundant memory access as recited in claim 8 wherein said direct connection is used for enhanced fail-over performance by the other one of said first memory controller or said second memory controller taking control of both said first memory and said second memory.

11. The apparatus for implementing redundant memory access as recited in claim 1 wherein said first memory and said second memory include a data buffer coupled to a plurality of memory chips.

12. The apparatus for implementing redundant memory access as recited in claim 11 wherein said plurality of memory chips include dynamic random access memory (DRAM) arranged as buffered memory with multiple dual inline memory module (DIMM) circuit cards.

13. The apparatus for implementing redundant memory access as recited in claim 1 wherein said first memory controller and said second memory controller includes an integrated microprocessor and memory controller.

14. A method for implementing redundant memory access in a memory system including a first memory and a second memory; a first memory controller and a second memory controller, each of said first memory controller and said second memory controller connected to both said first memory and said second memory; and said first memory controller and said second memory connected together; said method comprising:
using said first memory as a primary address space, for storage and fetches for said first memory controller and said first memory controller maintaining cache coherency for said first memory;
using said second memory as a primary address space, for storage and fetches for said second memory controller and said second memory controller maintaining cache coherency for said second memory;
responsive to one of said first memory controller or said second memory controller failing, notifying the other one of said first memory controller or said second memory controller of said failed controller; and
taking control of both said first memory and said second memory with the other one of said first memory controller or said second memory controller.

15. A method for implementing redundant memory access in a memory system as recited in claim 14 includes maintaining coherence of both said first memory and said second memory responsive to taking control of both said first memory and said second memory with the other one of said first memory controller or said second memory controller.

16. A method for implementing redundant memory access in a memory system as recited in claim 14 includes using a direct connection to both said first memory and said second memory for enhanced fail-over performance by the other one of said first memory controller or said second memory controller.

17. A design structure embodied in a machine readable medium used in a design process, the design structure comprising:
a memory system including a first memory and a second memory;
a first memory controller and a second memory controller, each of said first memory controller and said second memory controller connected to both said first memory and said second memory; said first memory controller and said second memory connected together;
said first memory controller using said first memory as its primary address space, for storage and fetches and maintaining cache coherency;
said second memory controller using said second memory as its primary address space, for storage and fetches and maintaining cache coherency;
a failing memory controller of said first memory controller or said second memory controller notifying the other one of said first memory controller or said second memory controller to take control of both said first memory and said second memory; and
wherein the design structure is used in a semiconductor system manufacture, and produces said memory system.

18. The design structure of claim 17, wherein the design structure comprises a netlist, which describes the memory system.

19. The design structure of claim 17, wherein the design structure resides on storage medium as a data format used for the exchange of layout data of integrated circuits.

20. The design structure of claim 17, wherein said first memory and said second memory include dynamic random access memory (DRAM).
